(19) United States
(12) Patent Application Publication
(10) Pub. No.: US 2019/0353992 A1
(43) Pub. Date: Nov. 21, 2019

(54) OPTICAL COMPONENT

(71) Applicant: Coretronic Corporation, Hsin-Chu (TW)

(72) Inventors: Shou-Cheng Huang, Hsin-Chu (TW); Chien-Chung Liao, Hsin-Chu (TW)

(73) Assignee: Coretronic Corporation, Hsin-Chu (TW)

(21) Appl. No.: 16/354,154

(22) Filed: Mar. 14, 2019

(30) Foreign Application Priority Data
May 18, 2018 (CN) 201820740748.9

(51) Int. Cl. G03B 21/14; G02B 7/02

(52) U.S. Cl. CPC G03B 21/145; G02B 7/02

(57) ABSTRACT

An optical component including a first optical element and two clip members is provided. The first optical element is located on a transmission path of a light beam. The two clip members are respectively disposed on two opposite ends of the first optical element. Each of the clip members includes a first stop portion, at least one second stop portion and at least one elastic portion. The first stop portion stops the first optical element along a first axial direction, the at least one second stop portion stops the first optical element along a second axial direction, and each of the clip members clips the first optical element via an elastic force of the elastic portion.

### CROSS-REFERENCE TO RELATED APPLICATION

This application claims the priority benefit of China application serial no. 201820740748.9, filed on May 18, 2018. The entirety of the above-mentioned patent application is hereby incorporated by reference herein and made a part of this specification.

### BACKGROUND

### Field of the Invention

The invention relates to an optical component and more particularly, to an optical component including a clip member.

### Description of Related Art

A projector is a display apparatus capable of generating an image anytime, anywhere. According to an imaging principle of the projector, an illumination light beam generated by a light source module is converted into an image light beam via a light valve, and afterwards, the image light beam is projected through a lens onto a screen or a wall to form an image. The lens in the projector is usually fixed with a diffusion sheet by means of fully glue dispensing and screw locking. However, the fixing manner by glue dispensing causes difficulty in reworking/reproduction, while the fixing manner by screw locking is troublesome and time-wasting. In addition, the diffusion sheet may also be fixed via an additionally disposed clip structure. However, the fixing manner which separately disposes the lens and the diffusion sheet occupies the larger disposition space in the projector, and a relative position between the lens and the diffusion sheet may fail to meet the expectation due to manufacturing and assembly tolerances, result in an unfavorable affection in the projection performance.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention were acknowledged by a person of ordinary skill in the art.

### SUMMARY OF THE INVENTION

The invention provides an optical component capable of compacting disposition space and facilitating assembly and reproduction.

Other features and advantages of the invention can be further understood by the technical features disclosed in the invention.

To achieve one, part, or all of the objectives aforementioned or other objectives, an embodiment of the invention provides an optical component including a first optical element and a clip member. The first optical element is located on a transmission path of a light beam. The clip member is disposed respectively on end portions of the first optical element. The clip member includes a first stop portion, at least one second stop portion and at least one elastic portion. The first stop portion stops the first optical element along a first axial direction, the at least one second stop portion stops the first optical element along a second axial direction, and the clip member clips the first optical element via an elastic force of the elastic portion.

Based on the above, the embodiments of the invention achieve at least one of the following advantages or effects. The optical component clips the optical element via the elastic force of the elastic portion of the clip member, and the stop portions of the clip member stop the optical element along a plurality of directions. Thereby, the optical element can be stably fixed for it to be easily assembled and reproduced. Moreover, the clip member can clip one or more optical elements without separately disposing the optical elements, so as to compact disposition space.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a three-dimensional (3D) diagram illustrating an optical component according to an embodiment of the invention.

FIG. 2 is a 3D diagram illustrating the optical component depicted in FIG. 1 from another view angle.

FIG. 3 is a 3D diagram illustrating an optical component according to another embodiment of the invention.

FIG. 4 is a 3D diagram illustrating an optical component according to yet another embodiment of the invention.

FIG. 5 is a 3D diagram illustrating an optical component according to still another embodiment of the invention.

FIG. 6 is a front-view diagram illustrating the first optical element and the second optical element depicted in FIG. 1.

FIG. 7 is a rear-view diagram illustrating the first optical element and the second optical element depicted in FIG. 1.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

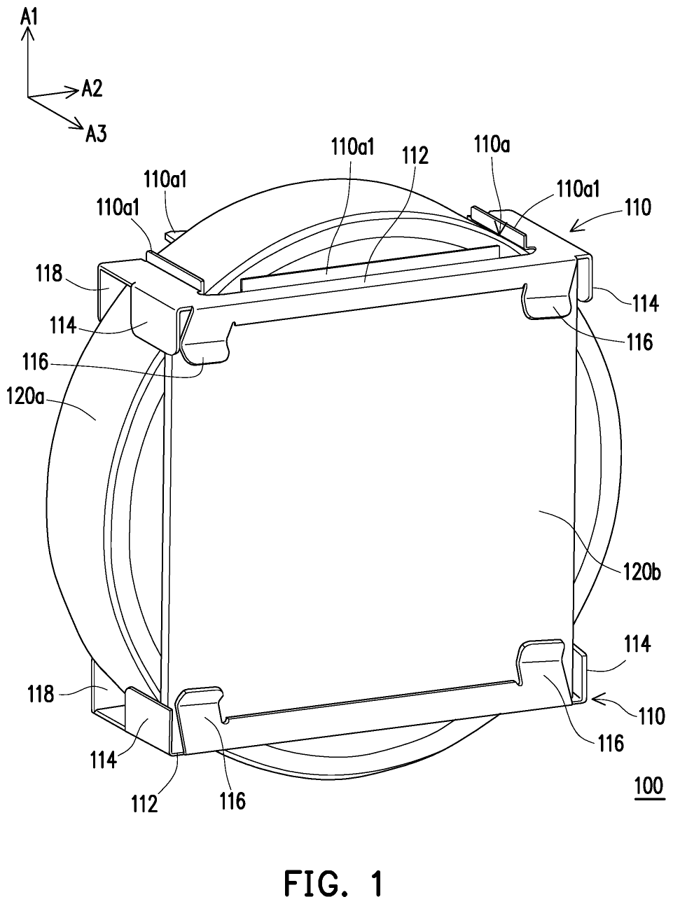

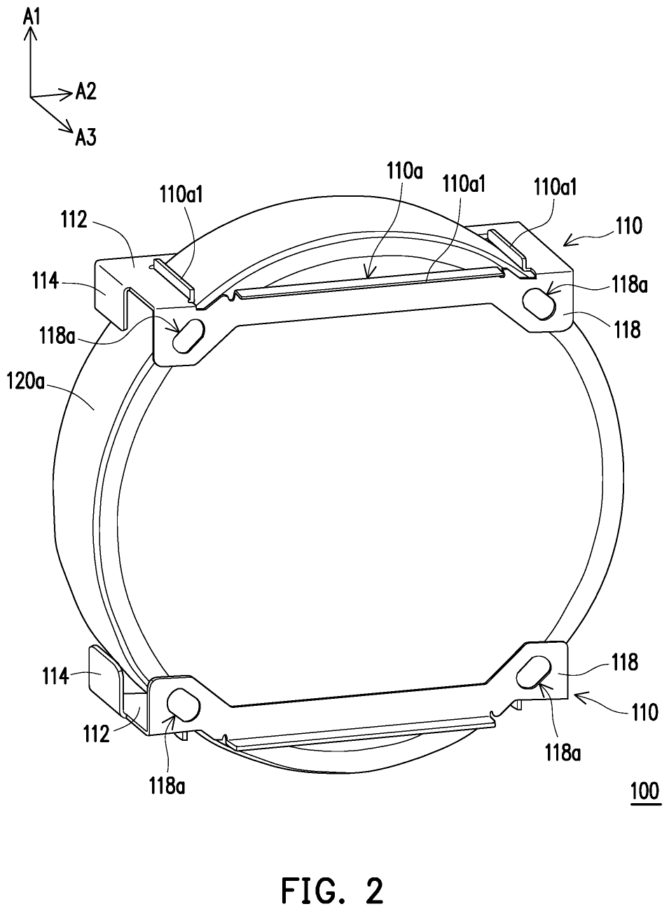

FIG. 1 is a three-dimensional (3D) diagram illustrating an optical component according to an embodiment of the invention. FIG. 2 is a 3D diagram illustrating the optical component depicted in FIG. 1 from another view angle. Referring to FIG. 1 and FIG. 2, an optical component 100 of the embodiment includes two clip members 110, a first optical element 120a and a second optical element 120b. The first optical element 120a is, for example, a lens in a projector, and the second optical element 120b is, for example, a diffusion sheet of the projector. The first optical element 120a and the second optical element 120b are located on a transmission path of a light beam, and the light beam is, for example, an illumination light beam from a light source of the projector. The second optical element 120b is stacked on the first optical element 120a.

The two clip members 110 are respectively disposed on two opposite ends of the first optical element 120a and two opposite ends of the second optical element 120b. Each of the clip members 110 includes a first stop portion 112, two second stop portions 114, two elastic portions 116 and a third stop portion 118. Each of the first stop portions 112 stops the first optical element 120a and the second optical element 120b from moving along a first axial direction A1, the two second stop portions 114 of each of the clip members 110 are respectively connected to the two opposite ends of the first stop portion 112, each of the second stop portions 114 stops the first optical element 120a and the second optical element 120b from moving along a second axial direction A2, and each of the third stop portions 118 stops the first optical element 120a from moving along a third axial direction A3. The two elastic portions 116 of each of the clip members 110 are connected to the first stop portion 112 and respectively correspond to the two opposite ends of the first stop portion 112, and each of the clip members 110 clips the first optical element 120a and the second optical element 120b between the third stop portions 118 and the elastic portions 116 via an elastic force of each of the elastic portions 116. The two clip members 110 are made of, for example, a metal or a plastic material.

As described above, the optical component 100 clips the first optical element 120a and the second optical element 120b via the elastic force of the elastic portions 116 of the clip members 110, such that the first optical element 120a and the second optical element 120b are partially connected to each other. In addition, the first stop portions 112 and the second stop portions 114 of the clip members 110 respectively stop the first optical element 120a and the second optical element 120b along different directions. Thereby, the first optical element 120a and the second optical element 120b may be stably fixed for them to be easily assembled and reproduced. Moreover, the clip members 110 may clip one or more optical elements without separately disposing the optical elements, so as to compact disposition space and reduce cost.

In the embodiment, the transmission path of the light beam passing through the first optical element 120a is, for example, parallel to the third axial direction A3, and the first axial direction A1, the second axial direction A2 and the third axial direction A3 are perpendicular to one another. In other embodiments, the first axial direction A1, the second axial direction A2 and the third axial direction A3 may not be perpendicular to one another, and the invention is not limited thereto.

Each of the clip members 110 of the embodiment has a slot 110a, and a part of the first optical element 120a protrudes from the slot 110a and is restricted in the slot 110a, thereby more stably fixing the first optical element 120a. In addition, each of the clip members 110 has a plurality of structural reinforcement ribs at a peripheral edge of the slot 110a, such that each of the clip members 110 has good structural strength.

In the embodiment, the two clip members 110 are designed to be symmetrically disposed to a geometric center of the first optical element 120a and a geometric center of the second optical element 120b, thereby restricting the geometric center of the first optical element 120a to be aligned to the geometric center of the second optical element 120b.

Referring to FIG. 1, each of the elastic portions 116 of the embodiment, for example, extends from the first stop portion 112 towards the second optical element 120b along a direction tilting with respect to the first axial direction A1, thereby providing an elastic clipping force along the third axial direction A3. In other embodiments, each of the elastic portions 116 may be designed in other manners, and the invention is not limited thereto.

Referring to FIG. 2, the third stop portion 118 of each of the clip members 110 of the embodiment has two glue dispensing openings 118a. Besides fixing the first optical element 120a and the second optical element 120b via the elastic force of each of the elastic portions 116 (illustrated in FIG. 1), the clip members 110 and the first optical element 120a may be further glue-dispensed through each of the glue dispensing openings 118a, thereby more stably fixing the first optical element 120a. In addition, the glue may be further dispensed between the first optical element 120a and the second optical element 120b, such that the glue is bonded between a peripheral edge of the first optical element 120a and the second optical element 120b or between a peripheral edge of the second optical element 120b and the first optical element 120a, which will be further described with reference to the accompanying drawings below.

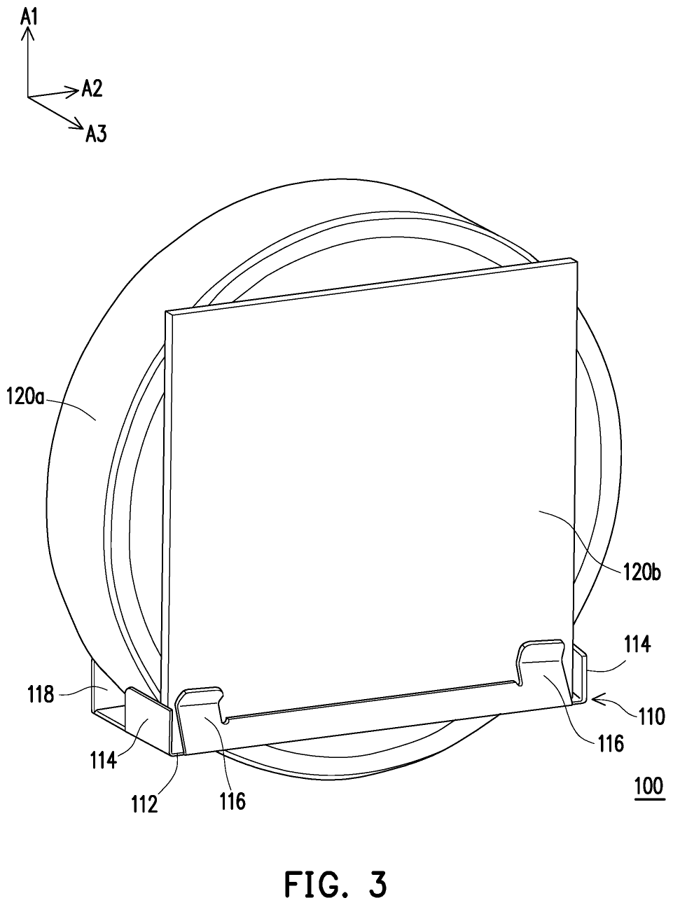

FIG. 3 is a 3D diagram illustrating an optical component according to another embodiment of the invention. Referring to FIG. 3, an optical component 100 of the embodiment is similar to the optical component illustrated in FIG. 1, and the difference therebetween lies in the optical component 100 of the embodiment requiring only one clip member 110. The optical component 100 of the embodiment includes a single clip member 110, and the single clip member 110 is disposed on an end portion of a first optical element 120a. The single clip member 110 includes a first stop portion 112, two second stop portions 114, two elastic portions 116 and a third stop portion 118. The first optical element 120a and the second optical element 120b may be fixed by single clip member 110, and on the other end portion of the first optical element 120a which is opposite to the single clip member 110, a part of the first optical element 120a and a part of the second optical element 120b are bonded by a glue and then fixed. Thereby, a geometric center of the first optical element 120a is aligned to a geometric center of the second optical element 120b.

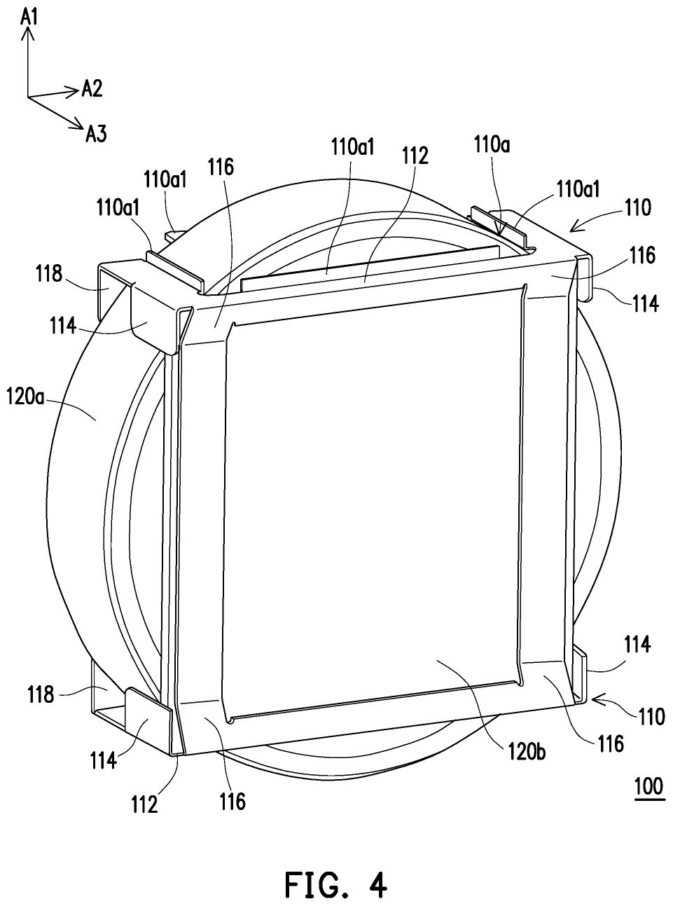

FIG. 4 is a 3D diagram illustrating an optical component according to yet another embodiment of the invention. Referring to FIG. 4, an optical component 100 of the embodiment is similar to the optical component illustrated in FIG. 1, and they are different in the structure of elastic portions 116. The two elastic portions 116 of the optical component 100 of the embodiment are respectively connected to two clip members 110, each of the elastic portions 116 forms a sheet structure, and each of the clip members 110 clips a first optical element 120a and a second optical element 120b between third stop portions 118 and the elastic portions 116 via an elastic force of each of the elastic portions 116. As described above, by clipping the first optical element 120a and the second optical element 120b via the elastic force of the elastic portions 116 of the clip members 110 of the optical component 100, the first optical element 120a and the second optical element 120b are connected to each other. In addition, each of the elastic portions 116 is, for example, flatly adhered to the optical component to be fixed. In the embodiment, each of the elastic portions 116 is, for example, flatly adhered to the second optical element 120b, and in other embodiments, without the second optical element 120b, each of the elastic portions 116 is, for example, flatly adhered to the first optical element 120a.

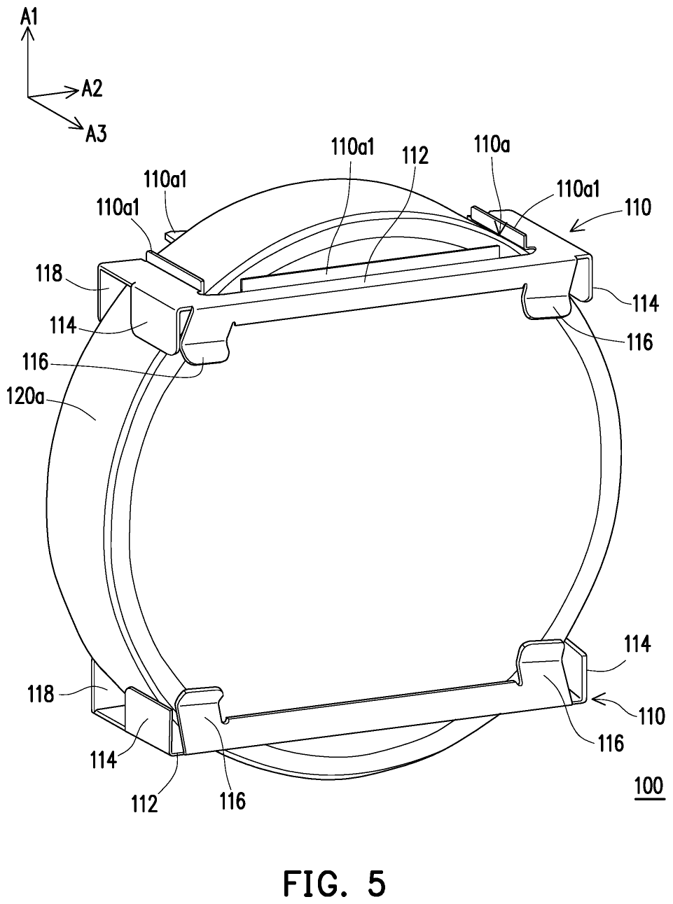

FIG. 5 is a 3D diagram illustrating an optical component according to yet another embodiment of the invention. Referring to FIG. 5, an optical component 100 of the embodiment is similar to the optical component illustrated in FIG. 1, and the difference therebetween lies in the optical component 100 employed to clip a single optical element.

The optical component 100 of the embodiment includes two clip members 110 and a first optical element 120a. The first optical element 120a is, for example, a lens in a projector. The first optical element 120a is located on a transmission path of a light beam, and the light beam is, for example, an illumination light beam from a light source of the projector. The two clip members 110 are respectively disposed on two opposite ends of the first optical element 120a. Each of the clip members 110 includes a first stop portion 112, two second stop portions 114, two elastic portions 116 and a third stop portion 118. Each of the first stop portions 112 stops the first optical element 120a from moving along a first axial direction A1, the two second stop portions 114 of each of the clip members 110 are respectively connected to two opposite ends of the first stop portion 112, each of the second stop portions 114 stops the first optical element 120a from moving along a second axial direction A2, and each of the third stop portions 118 stops the first optical element 120a from moving along a third axial direction A3. The two elastic portions 116 of each of the clip members 110 are connected to the first stop portion 112 and respectively correspond to the two opposite ends of the first stop portion 112, and each of the clip members 110 clips the first optical element 120a between the third stop portions 118 and the elastic portions 116 via the elastic force of each of the elastic portions 116.

As described above, the optical component 100 clips the first optical element 120a via the elastic force of the elastic portions 116 of the clip members 110. In addition, the first stop portions 112 and the second stop portions 114 of the clip members 110 respectively stop the first optical element 120a along different directions. Thereby, the first optical element 120a may be stably fixed for it to be easily assembled and reproduced. Thus, the optical elements do not have to be separately disposed, so as to compact disposition space and reduce cost.

In the embodiment, the transmission path of the light beam passing through the first optical element 120a is, for example, parallel to the third axial direction A3, and the first axial direction A1, the second axial direction A2 and the third axial direction A3 are perpendicular to one another. In other embodiments, the first axial direction A1, the second axial direction A2 and the third axial direction A3 may not be perpendicular to one another, and the invention is not limited thereto.

Each of the clip members 110 of the embodiment has a slot 110a, and a part of the first optical element 120a protrudes from the slot 110a and is restricted in the slot 110a, thereby more stably fixing the first optical element 120a. In addition, each of the clip members 110 has a plurality of structural reinforcement ribs at a peripheral edge of the slot 110a, such that each of the clip members 110 has good structural strength to prevent the clip member 110 from being distorted and deformed by a stress. In the embodiment, the two clip members 110 are designed to be symmetrically disposed to a geometric center of the first optical element 120a, thereby restricting the geometric center of the first optical element 120a to be aligned to an optical axial center of the illumination light beam, wherein the optical axial center is a main optical axial center of the transmission path of the light beam.

Referring to FIG. 5, each of the elastic portions 116 of the embodiment, for example, extends from the first stop portion 112 towards the first optical element 120a along a direction tilting with respect to the first axial direction A1, thereby providing an elastic clipping force along the third axial direction A3. In other embodiments, each of the elastic portions 116 may be designed in other manners, and the invention is not limited thereto.

Referring to FIG. 3 and FIG. 5, in other embodiments, one optical component 100 may clip the first optical element 120a merely with a single clip member 110, wherein the single clip member 110 is disposed on an end portion of the first optical element 120a.

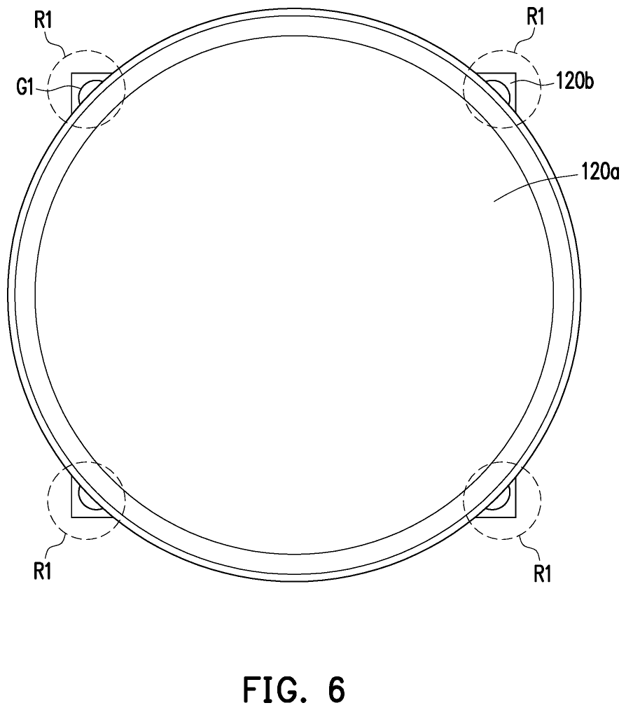

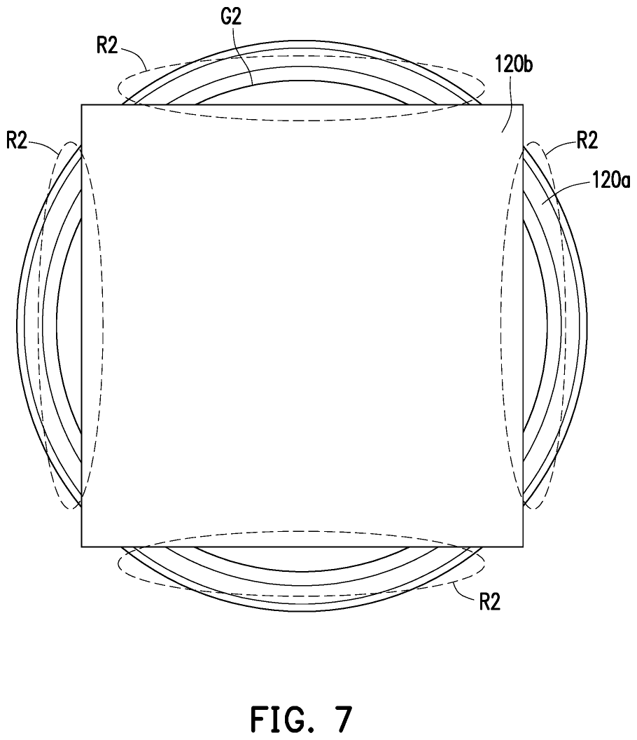

FIG. 6 is a front-view diagram illustrating the first optical element and the second optical element depicted in FIG. 1. FIG. 7 is a rear-view diagram illustrating the first optical element and the second optical element depicted in FIG. 1. Boundary regions R1 between the first optical element 120a and the second optical element 120b may be glue-dispensed in a manner as illustrated in FIG. 6, and boundary regions R2 between the first optical element 120a and the second optical element 120b may be glue-dispensed in a manner as illustrated in FIG. 7. In this way, the first optical element 120a and the second optical element 120b are bonded stably to each other by a glue G1 bonded between the peripheral edge of the second optical element 120b and the first optical element 120a and a glue G2 bonded between the peripheral edge of the first optical element 120a and the second optical element 120b. As a part of the glue G1 protrudes from the peripheral edges of the first optical element 120a and the second optical element 120b when the glue G1 and the glue G2 are dispensed on the boundary regions R1 and R2 between the first optical element 120a and the second optical element 120b, a stopping effect is provided.

In other embodiments, at least two boundary regions R1 between the first optical element 120a and the second optical element 120b are glue-dispensed, and at least two boundary regions R2 between the first optical element 120a and the second optical element 120b are glue-dispensed. Thereby, the first optical element 120a and the second optical element 120b are bonded stably to each other via the glue G1 bonded between the peripheral edge of the second optical element 120b and the first optical element 120a and via the glue G2 bonded between the peripheral edge of the first optical element 120a and the second optical element 120b, which simultaneously provides the stopping effect. For example, any two of the boundary regions R2 may be randomly selected for glue dispensing, thereby obtaining a stable bonding and stopping effect between the first optical element 120a and the second optical element 120b. With the clip members 110, the geometric center of the first optical element 120a is restricted to be aligned to the optical axial center of the illumination light beam, and the geometric center of the first optical element 120a is aligned to the geometric center of the second optical element 120b.

Based on the above, the embodiments of the invention can achieve at least one of the following advantages or effects. The optical component clips the optical elements via the elastic force of the elastic portions of the clip members, and the stop portions of the clip members stop the optical elements along a plurality of directions. Thereby, the optical elements can be stably fixed for them to be easily assembled and reproduced. Moreover, the clip members can clip one or more optical elements without separately disposing a plurality of optical elements, so as to compact the disposition space and reduce cost.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. An optical component, comprising:
a first optical element, located on a transmission path of a light beam; and
a clip member, disposed respectively on end portions of the first optical element, and the clip member comprising: a first stop portion, at least one second stop portion and at least one elastic portion, wherein the first stop portion stops the first optical element along a first axial direction, the at least one second stop portion stops the first optical element along a second axial direction, and the clip member clips the first optical element via an elastic force of the at least one elastic portion.

2. The optical component according to claim 1, wherein the transmission path of the light beam is parallel to a third axial direction, and the first axial direction, the second axial direction and the third axial direction are perpendicular to one another.

3. The optical component according to claim 1, wherein a geometric center of the first optical element is limited to be aligned to an optical axial center of the light beam.

4. The optical component according to claim 1, further comprising:
another clip member, wherein the two clip members are respectively disposed on two opposite ends of the first optical element.

5. The optical component according to claim 4, wherein the at least one elastic portion is respectively connected to the two clip members, and the at least one elastic portion forms a sheet structure.

6. The optical component according to claim 4, further comprising:
a second optical element, stacked on the first optical element and clipped by each of the clip members.

7. The optical component according to claim 6, wherein the two clip members are symmetrically disposed to a geometric center of the first optical element and a geometric center of the second optical element.

8. The optical component according to claim 1, further comprising:
a second optical element, stacked on the first optical element and clipped by the clip member, and on the other end portion of the first optical element which is opposite to the clip member, a part of the first optical element and a part of the second optical element are bonded by a glue and then fixed.

9. The optical component according to claim 1, wherein the clip member comprises a slot, and a part of the first optical element protrudes from the slot and is restricted in the slot.

10. The optical component according to claim 9, wherein the clip member has at least one structural reinforcement rib at a peripheral edge of the slot.

11. The optical component according to claim 1, wherein the clip member further comprises a third stop portion, the third stop portion stops the first optical element along a third axial direction, and the first optical element is clipped between the third stop portion and the at least one elastic portion.

12. The optical component according to claim 11, wherein the third stop portion has a glue dispensing opening.

13. The optical component according to claim 1, wherein the number of the at least one second stop portion is two, and the two second stop portions are respectively connected to two opposite ends of the first stop portion.

14. The optical component according to claim 1, wherein the number of the at least one elastic portion is two, and the two elastic portions are connected to the first stop portion and respectively correspond to two opposite ends of the first stop portion.

15. The optical component according to claim 1, wherein the elastic portion extends from the first stop portion towards the first optical element along a direction tilting with respect to the first axial direction.

16. The optical component according to claim 1, further comprising:
a second optical element and at least one glue, wherein the second optical element is stacked on the first optical element, the glue is bonded between a peripheral edge of the first optical element and the second optical element or between a peripheral edge of the second optical element and the first optical element.
